(19) United States
(12) Patent Application Publication
(10) Pub. No.: US 2023/0197097 A1
(43) Pub. Date: Jun. 22, 2023

(54) SOUND ENHANCEMENT METHOD AND RELATED COMMUNICATION APPARATUS

(71) Applicant: MEDIATEK INC., Hsin-Chu (TW)

(72) Inventors: Liang-Che Sun, Hsinchu City (TW); Yiou-Wen Cheng, Hsinchu City (TW); Chi-Sheng Wu, Hsinchu City (TW)

(73) Assignee: MEDIATEK INC., Hsin-Chu (TW)

(21) Appl. No.: 17/553,708

(22) Filed: Dec. 16, 2021

(51) Int. Cl. G10L 21/0232; G10L 25/18; G10L 25/60; G10L 17/06

(52) U.S. Cl. CPC G10L 21/0232; G10L 17/06; G10L 25/18; G10L 25/60

(57) ABSTRACT

A sound enhancement method is applied to a communication apparatus with an operation processor for increasing speech quality. The sound enhancement method includes the operation processor utilizing a sound receiver of the communication apparatus to acquire an input source, the operation processor applying a first calibration model to the input source for executing communication calibration and simultaneously analyzing the input source to determine whether to establish a second calibration mode, and the operation processor utilizing the second calibration mode to execute the communication calibration when the second calibration mode is established.

### BACKGROUND

The conventional Bluetooth earphone cannot provide preferred speech quality in a noisy environment. The conventional speech enhancement algorithm of the existing communication apparatus strengths all speech section and suppresses noise in the audio data, and the speech section of a specific user is not identified and particularly enhanced. In the noisy environment, the conventional speech enhancement algorithm does not distinguish the target speech section from the voice-like noise or the competing speech section in the audio data, and therefore the speech quality of the conventional Bluetooth earphone is debased because the voice-like noise and the competing speech section cannot be suppressed or removed.

### SUMMARY

The present invention provides a sound enhancement method with preferred speech quality and a communication apparatus for solving above drawbacks.

According to the claimed invention, a sound enhancement method is applied to a communication apparatus with an operation processor for increasing speech quality. The sound enhancement method includes the operation processor utilizing a sound receiver of the communication apparatus to acquire an input source, the operation processor applying a first calibration model to the input source for executing communication calibration and simultaneously analyzing the input source to determine whether to establish a second calibration mode, and the operation processor utilizing the second calibration mode to execute the communication calibration when the second calibration mode is established.

According to the claimed invention, the sound enhancement method further includes the operation processor replacing the first calibration model by the second calibration mode to calibrate the input source.

According to the claimed invention, the sound enhancement method further includes the operation processor utilizing the second calibration mode to calibrate another input source acquired by the sound receiver.

According to the claimed invention, each of the first calibration model and the second calibration mode comprises a mask relevant to a plurality of sound information vectors, and the operation processor utilizes the mask to remove sound data not belonging to an authenticated user inside the input source.

According to the claimed invention, the plurality of sound information vectors is a pitch feature and a spectrum feature of the authenticated user.

According to the claimed invention, the sound enhancement method further includes the operation processor determining whether the input source comprises a near end sound and a far end sound, and the operation processor analyzing the near end sound to establish the second calibration mode when the input source only comprises the near end sound.

According to the claimed invention, the sound enhancement method further includes the operation processor not establishing the second calibration mode via the input source when the input source comprises the far end sound.

According to the claimed invention, the sound enhancement method further includes the operation processor further analyzing whether quality of the near end sound conforms to a predefined threshold when the input source only comprises the near end sound, and the operation processor analyzing the near end sound to establish the second calibration mode when the quality of the near end sound conforms to the predefined threshold.

According to the claimed invention, the sound enhancement method further includes the operation processor not establishing the second calibration mode via the input source when the quality of the near end sound does not conform to the predefined threshold.

According to the claimed invention, the sound enhancement method further includes the operation processor extracting a plurality of sound information vectors from the input source and arranging several clusters of the plurality of sound information vectors and known sound information vectors preset in a database of the communication apparatus, the operation processor determining whether the input source belongs to an authenticated user within a user list of the communication apparatus in accordance with a clustering result, and the operation processor analyzing the input source to establish the second calibration mode when the input source belongs to the authenticated user.

According to the claimed invention, the sound enhancement method further includes the operation processor not establishing the second calibration mode via the input source when the input source does not belong to the authenticated user.

According to the claimed invention, the sound enhancement method further includes the operation processor further analyzing whether quality of the input source conforms to a predefined threshold when the input source belongs to the authenticated user, and the operation processor analyzing the input source to establish the second calibration mode when the quality of the input source conforms to the predefined threshold.

According to the claimed invention, the sound enhancement method further includes the operation processor not establishing the second calibration mode via the input source when the quality of the input source does not conform to the predefined threshold.

According to the claimed invention, a communication apparatus with preferred speech quality includes a database, a sound receiver and an operation processor. The database is adapted to store a first calibration model. The sound receiver is adapted to receive an input source. The operation processor is electrically connected to the database and the sound receiver. The operation processor applies the first calibration model to the input source for communication calibration, and simultaneously analyzes the input source to determine whether to establish a second calibration mode into the database for replacing the first calibration model by the second calibration mode to execute the communication calibration.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a communication apparatus according to an embodiment of the present invention.

FIG. 2 is a flow chart of a sound enhancement method according to the embodiment of the present invention.

FIG. 3 is a flow chart of activation of the training controller according to the embodiment of the present invention.

FIG. 4 is a flow chart of activation of the update controller according to the embodiment of the present invention.

### DETAILED DESCRIPTION

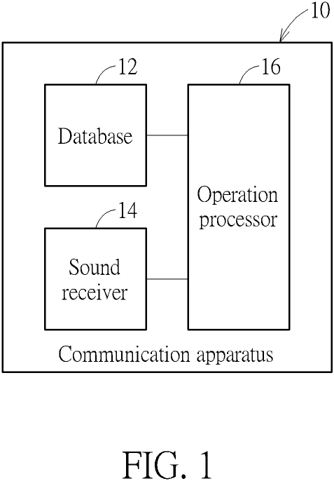

Please refer to FIG. 1. FIG. 1 is a functional block diagram of a communication apparatus 10 according to an embodiment of the present invention. The communication apparatus 10 can be used in an earphone or a smart phone, or a tablet computer or a notebook computer with communication function. The communication apparatus 10 can have a real-time user unaware improvement model for sound enhancement via a personalized sound enhancement algorithm, which can automatically identify and reserve sound of one or some authenticated users and remove unauthenticated sound. The sound enhancement can include speech enhancement and any possible acoustic enhancement. The unauthenticated sound may be voice of the unauthenticated users or voice-like noise, such as television news or broadcasting.

Further, the communication apparatus 10 can utilize at least one calibration model to execute communication calibration for a start, and the foresaid calibration model can be immediately updated in accordance with a current sound and applied for the communication calibration during the phone call or after the phone call. Therefore, the communication apparatus 10 can provide preferred noise reduction performance and preferred target sound extraction when the authenticated user is in the phone call and unaware of the automatically updated calibration model.

The communication apparatus 10 can include a database 12, a sound receiver 14 and an operation processor 16. The sound receiver 14 can be a microphone or a transmission unit used to receive an input source, and the input source may be sound data generated by an owner and any passerby close to the communication apparatus 10 and/or voice-like noise. The database 12 can be a memory or any other type of storage unit used to store at least one calibration model for calibration of the input source. The operation processor 16 can be electrically connected to the database 12 and the sound receiver 14, and calibrate the input source via the first-phase calibration model and further determine whether to transform the first-phase calibration model into the second-phase calibration model for further calibrating the input source.

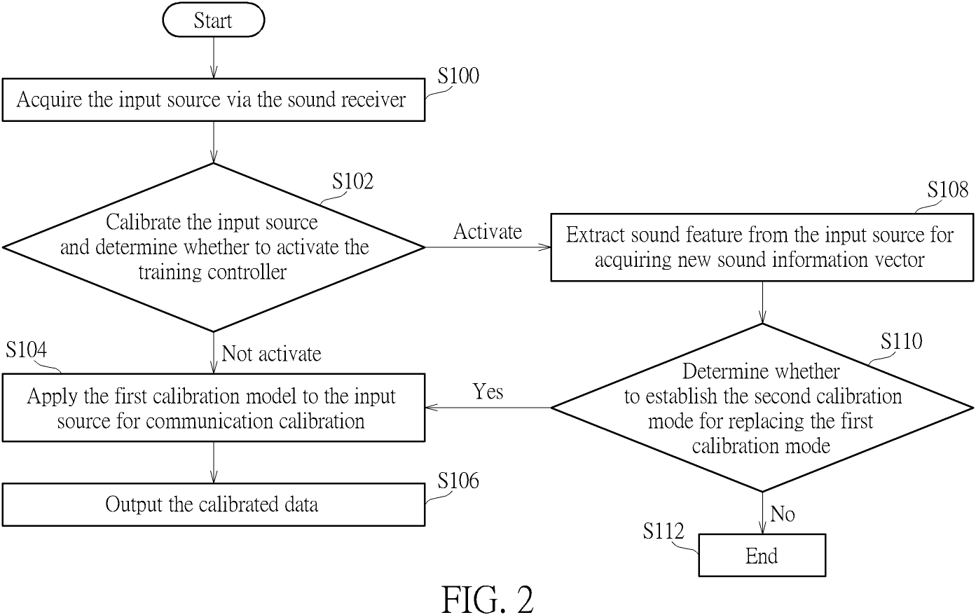

Please refer to FIG. 2. FIG. 2 is a flow chart of a sound enhancement method according to the embodiment of the present invention. The sound enhancement method illustrated in FIG. 2 can be suitable for the communication apparatus 10 shown in FIG. 1. First, step S100 can be executed that the operation processor 16 can acquire the input source via the sound receiver 14. Then, step S102 can be executed that the operation processor 16 can calibrate the input source via one calibration model and further analyze the input source to determine whether to activate a training controller for transforming the foresaid calibration model. It should be mentioned that an order of calibration of the input source and activation of the training controller in step S102 is not limited the above-mentioned embodiment, which can be executed reversely or simultaneously and depends on a design demand.

If step S102 does not activate the training controller, steps S104 and S106 can be executed that the operation processor 16 can apply a first calibration model to the input source for executing the communication calibration, and then output calibrated data that has clean voice. In step S104, the first calibration model can have preset sound information vectors from sound features of the previous input source; the communication calibration may execute the source localization to search orientation of someone who speaks, execute the beamforming function to find out a preferred sound transmission path, execute the noise reduction to optimize acoustic quality of the input source, and execute the sound reconstruction to acquire the clean voice.

If step S102 activates the training controller, step S108 can be executed to extract sound feature from the input source for acquiring new sound information vector, and then step S110 can be executed to determine whether to activate an update controller for establishing a second calibration mode for replacing the first calibration mode. If the update controller satisfies an activating condition, the second calibration mode can be established, and the first calibration mode applied in step S104 can be replaced by the second calibration mode for the communication calibration; if the update controller does not satisfy the activating condition, the second calibration mode cannot be established, and step S112 can be executed to end the sound enhancement method and step S104 can still apply the first calibration mode for next communication calibration.

In the present invention, each of the first calibration model and the second calibration mode can contain at least one mask relevant to a plurality of sound information vectors, and the plurality of sound information vectors can be a pitch feature and/or a spectrum feature extracted from the input source of the authenticated user. The mask can at least include a speech segment that has a high gain value and a noise segment that has a low gain value. The operation processor 16 can compute an inner product of the mask and the input source, so as to remove some specific sound data (which does not belong to the authenticated user) inside the input source. The other sound data (which belongs to the vocal voice of the authenticated user) inside the input source can be transformed into the sound information vectors via the voice embedding network for economizing storage capacity of the database 12.

For example, if the communication apparatus 10 acquires the one minute’s input source, the sound enhancement method can utilize the first calibration model to calibrate a first half of the input source, and simultaneously analyze the first half of the input source to determine whether to establish the second calibration mode. If the second calibration mode is established, the sound enhancement method may utilize the first calibration model to calibrate a second half of the input source yet and the second calibration mode can be applied for another input source, or the sound enhancement method may replace the first calibration model with the second calibration mode and then apply the second calibration mode to calibrate the second half of the input source. Therefore, the first calibration model can be updated and transformed into the second calibration mode during the phone call, and the second calibration mode can be optionally applied for the current input source or a following input source.

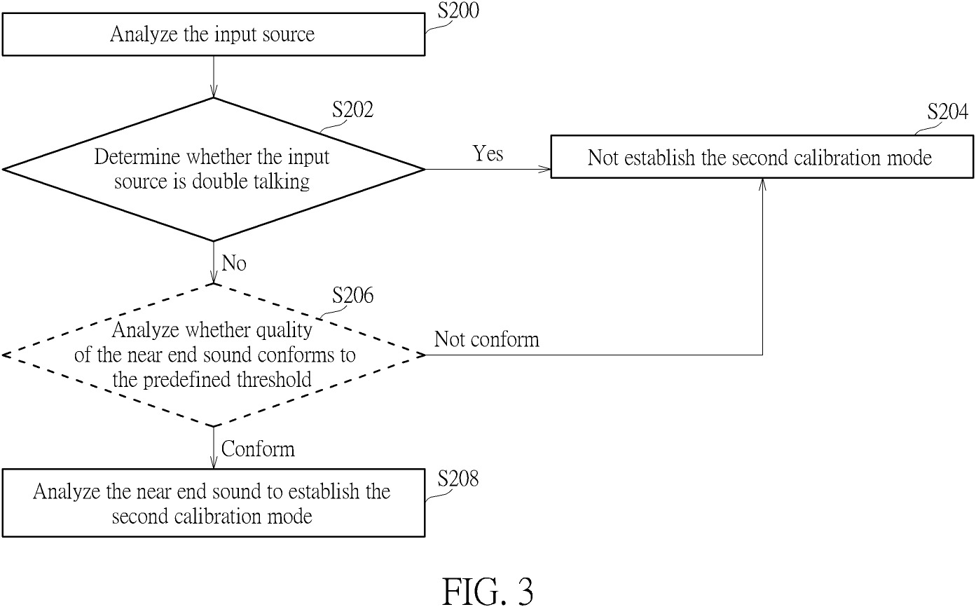

Please refer to FIG. 3. FIG. 3 is a flow chart of activation of the training controller according to the embodiment of the present invention. First, steps S200 and S202 can be executed to analyze the input source and determine whether the input source is double talking. The double talking may be interpreted as having a far end sound from the passerby and a near end sound from the authenticated user. If the input source is the double talking that includes the sound date of the passerby and the authenticated user, or not the double talking but only includes the far end sound, step S204 can be executed to not establish the second calibration mode via the input source, and the training controller is not activated. If the input source is not the double talking and only includes the near end sound, step S206 can be executed to analyze whether the acoustic quality of the near end sound conforms to a predefined threshold. When the acoustic quality of the near end sound does not conform to the predefined threshold, step S204 can be executed to not establish the second calibration mode via the input source; when the acoustic quality of the near end sound conforms to the predefined threshold, step S208 can be executed to activate the training controller and analyze the near end sound of the input source for establishing the second calibration mode.

In one possible situation, the operation processor 16 may directly analyze the near end sound to establish the second calibration mode when the input source only includes the near end sound, which is interpreted that step S206 can be removed and step S208 can be executed after a negative result of step S202 is acquired. Thus, quality estimator in step S206 can be an optional unit used to compare the acoustic quality of the near end sound with the predefined threshold. The quality estimator can be an artificial intelligence model that utilizes signal-to-noise ratio (SNR) or perceptual evaluation of speech quality (PESQ) to estimate the acoustic quality. The predefined threshold can be a norm, a quota or an index of SNR and/or PESQ technology, which depends on the design demand, and computation of an actual value of the predefined threshold is omitted herein for simplicity.

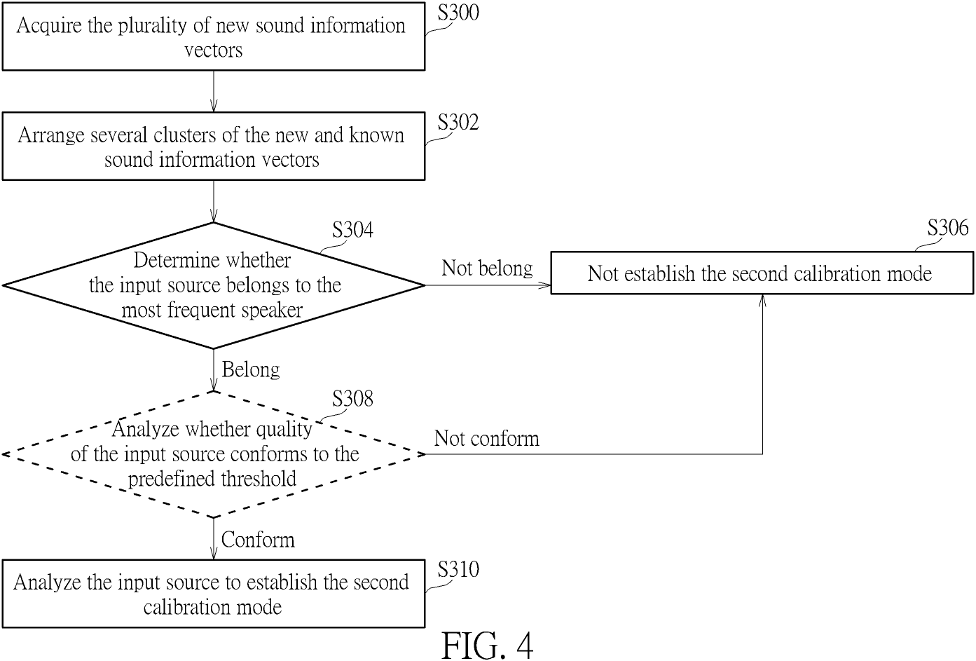

Please refer to FIG. 4. FIG. 4 is a flow chart of activation of the update controller according to the embodiment of the present invention. First, steps S300 and S302 can be executed to acquire the plurality of new sound information vectors from step S108, and add the plurality of new sound information vectors into the database 12 for arranging several clusters of the plurality of new sound information vectors and known sound information vectors preset inside the database 12. Then, step S304 can be executed to determine whether the new sound information vectors of the input source belong to the authenticated user within a user list of the communication apparatus 10 in accordance with a clustering result. The user list may collect the sound data of several users, and one of the collected users who is the most frequent speaker can be defined as the authenticated user, and others can be defined as the unauthenticated user.

If the new sound information vectors of the input source do not belong to the authenticated user within the user list, step S306 can be executed to not establish the second calibration mode via the input source. If the new sound information vectors of the input source belong to the authenticated user within the user list, step S308 can be executed to analyze whether the acoustic quality of the input source conforms to the predefined threshold. The quality estimator in step S308 can be similar to the quality estimator in step S208; that is, when the acoustic quality of the input source does not conform to the predefined threshold, step S306 can be executed to not establish the second calibration mode. When the acoustic quality of the input source conforms to the predefined threshold, step 310 can be executed to analyze the input source and establish the second calibration mode.

In another possible situation, the operation processor 16 may directly analyze the input source to establish the second calibration mode when the input source belongs to the authenticated user, which is interpreted that step S308 can be removed and step S310 can be executed after a positive result of step S304 is acquired. The user list in step S304 may contain several users; for example, ten users may be ordered in the user list according to their frequency of occurrence, and the operation processor 16 can identify whether the input source belongs to the most frequent user in the user list, so as to actuate the quality estimator in step S308 accordingly.

In conclusion, the communication apparatus executes the sound enhancement method of the present invention in a specific time period of the input source, and a segment of the input source is abandoned after being used to transform the calibration mode. For example, the communication apparatus may set the specific time period of each segment equal to five seconds. When the phone call is picked up, the communication apparatus can define a period of the phone call from the first second to the fifth second as being a first segment of the input source. The first segment can be calibrated by the first calibration model, and simultaneously the sound information vectors of the first segment can be extracted to establish the second calibration model; then, the first segment can be immediately abandoned and not stored into the database in response to the established second calibration model. As if the phone call is still online, the communication apparatus can define another period of the phone call from the sixth second to the tenth second as being a second segment of the input source. The second calibration model can be applied to immediately calibrate the second segment of the input source when receiving the second segment, or can be applied to calibrate the following input source received by the communication apparatus after the previous input source is ended.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sound enhancement method applied to a communication apparatus with an operation processor, comprising:
the operation processor utilizing a sound receiver of the communication apparatus to acquire an input source;
the operation processor applying a first calibration model to the input source for executing communication calibration and simultaneously analyzing the input source to determine whether to establish a second calibration mode; and
the operation processor utilizing the second calibration mode to execute the communication calibration when the second calibration mode is established.

2. The sound enhancement method of claim 1, wherein the operation processor utilizing the second calibration mode to execute the communication calibration comprises:
the operation processor replacing the first calibration model by the second calibration mode to calibrate the input source.

3. The sound enhancement method of claim 1, wherein the operation processor utilizing the second calibration mode to execute the communication calibration comprises:
the operation processor utilizing the second calibration mode to calibrate another input source acquired by the sound receiver.

4. The sound enhancement method of claim 1, wherein each of the first calibration model and the second calibration mode comprises a mask relevant to a plurality of sound information vectors, and the operation processor utilizes the mask to remove sound data not belonging to an authenticated user inside the input source.

5. The sound enhancement method of claim 4, wherein the plurality of sound information vectors is a pitch feature and a spectrum feature of the authenticated user.

6. The sound enhancement method of claim 1, further comprising:
the operation processor determining whether the input source comprises a near end sound and a far end sound; and
the operation processor analyzing the near end sound to establish the second calibration mode when the input source only comprises the near end sound.

7. The sound enhancement method of claim 6, further comprising:
the operation processor not establishing the second calibration mode via the input source when the input source comprises the far end sound.

8. The sound enhancement method of claim 6, further comprising:
the operation processor further analyzing whether quality of the near end sound conforms to a predefined threshold when the input source only comprises the near end sound; and
the operation processor analyzing the near end sound to establish the second calibration mode when the quality of the near end sound conforms to the predefined threshold.

9. The sound enhancement method of claim 8, further comprising:
the operation processor not establishing the second calibration mode via the input source when the quality of the near end sound does not conform to the predefined threshold.

10. The sound enhancement method of claim 1, further comprising:
the operation processor extracting a plurality of sound information vectors from the input source and arranging several clusters of the plurality of sound information vectors and known sound information vectors preset in a database of the communication apparatus;
the operation processor determining whether the input source belongs to an authenticated user within a user list of the communication apparatus in accordance with a clustering result; and
the operation processor analyzing the input source to establish the second calibration mode when the input source belongs to the authenticated user.

11. The sound enhancement method of claim 10, further comprising:
the operation processor not establishing the second calibration mode via the input source when the input source does not belong to the authenticated user.

12. The sound enhancement method of claim 10, further comprising:
the operation processor further analyzing whether quality of the input source conforms to a predefined threshold when the input source belongs to the authenticated user; and
the operation processor analyzing the input source to establish the second calibration mode when the quality of the input source conforms to the predefined threshold.

13. The sound enhancement method of claim 12, further comprising:
the operation processor not establishing the second calibration mode via the input source when the quality of the input source does not conform to the predefined threshold.

14. A communication apparatus with preferred speech quality, comprising:
a database adapted to store a first calibration model;
a sound receiver adapted to receive an input source; and
an operation processor electrically connected to the database and the sound receiver, the operation processor applying the first calibration model to the input source for communication calibration, and simultaneously analyzing the input source to determine whether to establish a second calibration mode into the database for replacing the first calibration model by the second calibration mode to execute the communication calibration.

15. The communication apparatus of claim 14, wherein the operation processor applies the second calibration mode to the input source for the communication calibration, or applies the second calibration mode to another input source acquired by the sound receiver for the communication calibration.

16. The communication apparatus of claim 14, wherein the first calibration model and the second calibration mode respectively comprise a mask relevant to a plurality of sound information vectors, the plurality of sound information vectors is a pitch feature and a spectrum feature of an authenticated user, and the operation processor utilizes the mask to remove sound data not belonging to the authenticated user inside the input source.

17. The communication apparatus of claim 14, wherein the operation processor determines whether the input source comprises a near end sound and a far end sound, and analyzes the near end sound to establish the second calibration mode when the input source only comprises the near end sound.

18. The communication apparatus of claim 17, wherein the operation processor further analyzes whether quality of the near end sound conforms to a predefined threshold, and analyzes the near end sound to establish the second calibration mode when the quality of the near end sound conforms to the predefined threshold.

19. The communication apparatus of claim 18, wherein the operation processor does not establish the second calibration mode via the input source when the input source comprises the far end sound, or when the quality of the near end sound does not conform to the predefined threshold.

20. The communication apparatus of claim 14, wherein the operation processor extracts a plurality of sound information vectors from the input source and arranges several clusters of the plurality of sound information vectors and stored sound information vectors in the database, and analyzes the input source to establish the second calibration mode when the input source belongs to an authenticated user within a user list of the communication apparatus in accordance with a clustering result.

21. The communication apparatus of claim 20, wherein the operation processor further analyzes whether quality of the input source conforms to a predefined threshold, and analyzes the input source to establish the second calibration mode when the quality of the input source conforms to the predefined threshold.

22. The communication apparatus of claim 21, wherein the operation processor does not establish the second calibration mode via the input source when the input source does not belong to the authenticated user, or when the quality of the input source does not conform to the predefined threshold.
